(19) United States
(12) Patent Application Publication
(10) Pub. No.: US 2015/0224840 A1
(43) Pub. Date: Aug. 13, 2015

(54) Airtrain & Hydroairtrain

(71) Applicant: Brian Lee Uitdenbogerd, Las Vegas, NV (US)

(72) Inventor: Brian Lee Uitdenbogerd, Las Vegas, NV (US)

(21) Appl. No.: 14/176,397

(22) Filed: Feb. 10, 2014

(51) Int. Cl. B60F 5/02; B64C 3/00; F02K 1/54; B64D 33/04; B60V 1/00; B64C 1/00; B64D 11/00

(52) U.S. Cl. CPC B60F 5/02; B64C 1/00; B64C 3/00; B64D 11/00; B64D 33/04; B60V 1/00; F02K 1/54

(57) ABSTRACT

This invention is an airtrain, it is a half airplane and a half train. All parts and their functions are the exactly same as an airplane. It looks like a train but it functions and operates like an airliner. It does not fly in high altitude like an airliner but it stays close to the ground level in the ground effect. It is a two large airliner symmetrically joined together rear to rear of another same type of airliner. Depending on the configuration of an airtrain the speed and passenger carrying capability can easily surpass the speed trains that are operational today. An airtrain power comes from jet engines totally independent from electricity and steel tracts and by not having them it offers many advantages. This eliminates the complicated electrical power grids and wiring along the tracks which translates into billions of dollars in savings.

### BACKGROUND OF THE INVENTION

It is a half airliner and half train, FIG. 6. Airtrain is equipped with jet engines and not relying on the electrical power grids or electricity for its power. Airtrain can fly in ground effects FIG. 2, fly on flat surfaces, its ramps, road, or on a body of water. If needed, airtrain can fly over the mountains. Airtrain does not need steel tracks, sliding, gliding or confined to any retainer walls to keep it on course. It has the freedom just like an airliner but flys above the ground or on top of the water in a ground effect. Airtrain can take off and land from the ramps built like a runway in airports. FIG. 10, Hydroairtrain is built and configured to fly in ground effects on water, take off or land on water.

### BRIEF SUMMARY OF THE INVENTION

### Technical Problem

Can a speed train be built that are independent from the steel tracks, electricity or retainers walls to keep them in place? The train that has the free movements, up, down, yaws (turn) right and left and roll left and right as an airplane. Have the trains to get more power to travel at faster speed and haul more passengers and cargo like an airplane. Like the airplane, it is totally independent from the electrical power source and the steel tracks of any sort. The technology behind the speed train today is from electricity is the significant improvements and so is the steel tracks. The speed train technology in the last 20 years has made great advances. Today many countries own and operate speed trains that can travel over 300 miles per hour. All most all the speed trains have in common are that they rely on their power source is from electricity and they have to run on steal tracks, or slide above the steal tracks. The trillion dollar question is can the speed train can continue to grow, travel faster and carry more passengers and cargo safely in the future. If so what about the cost it will require building these futuristic speed trains continue to depend on electricity as its power and continue to depend on steel tracks. Can the speed train industry can sustain its development and growth in the future continue to using the electricity as its power plant to meet the demands of the mass transport systems in the future or do we need to find some thing else. As it did with the steam industry, as the electrical engines came out, it replaced the steam engines. Is in it time that we find a replacement for electric and steel tracks to replace the current speed train industry to more modern as an airtrain. If we look at the cost benefit factors on the foot per foot investments the people need to choose, the speed trains, electricity and steel tracks or, Airtrain, jet powered and no track system. The question would than be when a speed train can be able to speed in the excess of 400 or 500 miles per hour carry the twice as many passengers and cargo. To do so how much more time, the years of research and investment will be required for the speed trains to travel the same as an airliner? Once the speed trains can travel fast like an airliner, safe, readily accessible than more passengers will use it. Another problem with the speed trains today is that it requires lot of work laying electrical cables on miles and miles down the train tracks. Can you image what the cost to cover the United States with electrical cable for the speed train. It would cost in the billions of dollars but once it is in place, it will take billions dollars to maintain. Electric power plants and lines have to be maintaining constantly to get that high quality voltage power output demanded by the speed trains. In fact, the some parts of the remote far distance from the power source it is almost impossible to pull the electrical power to those areas. There are many other limitations in powering the speed train using the electricity and steel tracks and it all translates into loss of time and money. The continual investment in the electric speed train would it pay off in the future or is it about the time we find other means supplement the speed train. As it did in the past, the speed trains supplemented other train systems that traveled at much slower speed. The limitations can only over come by the investment of billions of dollars in the speed train and no matter how much and you invest in this technology the technology has its limitations as it did with the fax machines and VCR, video cassette recorders. As it did with the steam engines was replaced by the electrical power trains. The electrical power too have its maximum capacity and it is about time we research and implement the new technology that can reduce the cost to make its platforms, safer and run like the airliners and perhaps supplement the speed train system that are being used today.

### Technical Solution

By utilizing the two same-type of airliner and joining the airliners symmetrically, and the wing areas can be reduced or increased to get the best effect of the ground effect. The joined airliners will look like this FIG. 3. All the parts are there as same as an airplane but the configuration are changed but all the parts and the functions are the same as an airliner. Just like the single airliner. The airtrain does not rely on the electrical power; thus, no electrical wires have to be pulled along side of the tracks. No steel tracks have to be laid. The only thing it needs a narrow runway, ramp, FIG. 11, a small road for airtrain to land incase of an emergency, along its course. This could be a road that can handle the weight of an airliner to take offs and landing. We know how to make roads and the technology on making the roads are highly advanced now and we can make it relatively cheap and quickly. Airtrain will have automatic pilot but it will be more smart system such as GPS, balance and altitude watch systems built into for maintaining movements in millimeters in the lateral and horizontal movements using a smart system built in the belly of the airtrain near the CG center of gravity to constantly monitoring the surroundings and sending back the information to the on board computers that controls the systems of an airtrain to stay on its course and set altitude with a minimal deviation with in millimeter in lateral or horizontal movements at a speeding of an airliner. Most airliners are able to fly in the speed of Mach 0.85, (about 900 km/h or 560 mph). So can an airtrain with the same aerodynamic body, fuselage and powerful engines the airtrain can easily match an airliners performance and capability. Symmetrically combining the two same type airliner with a proven aero dynamic designs and capability it has the aerodynamic designs the capability to perform like airliner but it is an airtrain without any external power source such as electricity or steel tracks. Their only powers sources are the engines under the wings or on top the wings for the Hydroairtrains. FIG. 10. We all know that laying road over a mountain is a tough business. Unlike the pains, it will not be a straight line and many cases, have to build tunnels to get through some tough mountainous terrains. Why bother building roads, ramps, through the mountains. Airtrain has all the functions as an airliner, just fly over it and when it needs to. Once it is on the other side of the mountain, it can be airtrain again, going in on a ground effect flying to its destination and it does not need any thing except the flat surface. The ramps are for incase of emergency when it needs to put it down if it necessary. Around costal states one does not even need to build roads, ramps. Airtrain can fly on a ground effects on top of the water off the costal line. The ramps can be built on the water so the airtrain can use it incase of an emergency when it has to land, or simply land it on the water if it is Hydroairtrain equipped with right floating equipments. FIG. 10.

### ADVANTAGEOUS EFFECTS OF INVENTION

Completely independent from electricity, steel tracks and the speeds of an airliner would be hard to beat. Since airtrain is two of the same time type of airliner joined back to rear to rear to produce to make one airliner transformed, configured differently but function as an airtrain but will have the functions and speed equivalent of an airliner. Airtrain is not only fast but it will be safe but can haul almost the twice as many passengers and cargo at one given time. It functions just like airplane with all the systems are exactly the same as an airplane. It is a 100% transfer of airplane technology, building an airliner to a new technology into building an airtrain, symmetrical two airliners joined end to end to produce an airtrain that performs and operate safely as an airliner. Thus, we all ready have lot of the experiences and knowledge in building the airliner and we can transfer this information and using it for building a train. A totally a different system that does not rely on the electricity nor the steel tracks. Transforming two airliners in to one airtrain would give a head start over trying to find some other concept of speed train systems. Investing in the transfer of airliner technology will be far more cost effective and cost effective. Transforming an airliner into an airtrain will be the safe and proven investment for the future of the speed trains that can travel the same speed, safe and as an airliner but it will be far cheaper to operate and maintain in the future. Can you image configuring the two of the same types, the world's larges airliners transforming them in an airtrain. Even an Airbus A380 or even Boeing 747-8 can be symmetrically jointed rear to rear to make the truly the worlds largest airtrain in the world with the current available technology. Also the platform or ramps are simply a road with out any steel tracks, easy to build and easy to maintain. It can be just a road, a narrow runway used only for emergency landing. In costal states where there is water, fly on top of the water off the costal line. No need for the ramps and road. You can build ramps for emergency landings; it can land on it or land on the water if there are no ramps near by. The way the two same type of airliner is joined end to end, it can float with the perfect balance. See FIG. 10. In fact, if you were to mount the engines on top of the wings, out of the way from the water, it may be able to take off from the water. The key for the platform is to give a place for airtrain to land at any places in case of an emergency and also it keeps the airtrain on its course by following the plat form. A constant monitoring, sensors on the airtrain will constantly monitors the surroundings to make sure that the airtrain is on its course, safely flying on its course on top of the platforms and maintaining its speed, balance and altitudes a wing length or two above from the ground. If it needs to go over a mountain, it can go over it, but it can divert it to go on water until it has cleared the mountains and back on the shore where the ramp is or it can continue its flight on water. No need to depend on the tracks and electricity. This is like going from using a calculator to using a computer. Airtrain can transform speed trains or supplement them the mass transit systems we have today. This is like going from analog to digital age in the mass transit system.

### BRIEF DESCRIPTION OF DRAWINGS

FIG. 1 is a drawing of an airliner with its parts and functions. Airliner and the airtrain have the same parts but in a different configuration but the airtrain will work the same way as an airliner.

FIG. 2 illustrates ground effects relative to an airplane.

FIG. 3 is a side view of airliner jointed rear to rear would look like to form the new airtrain.

FIG. 4 is a side view of the airtrain with different configuration than the airliner would look on its ramp.

FIG. 5 is a perspective view of the airtrain on its platform.

FIG. 6 is a side view of the airtrain in flight would look like.

FIG. 7 is a front view of the airtrain rear to rear with modification to show how it would look from the front.

FIG. 8 is a top view of the airtrain with modifications to show how the airtrain would look like from the top. The engines are facing in the opposite directions.

FIG. 9 is a top view of the airtrain would look like. The engines are facing in the same directions.

FIG. 10 is a top view of the airtrain platform would look like.

FIG. 11 is a side view of the airtrain platform would look like.

FIG. 12 is a top view of the airtrain platform would look like.

FIG. 13 is a front view of the airtrain platform would look like.

### DETAILED DESCRIPTION OF EMBODIMENTS

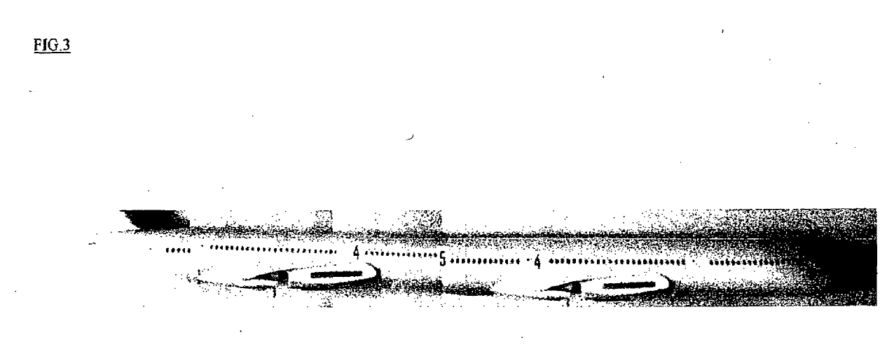

Now, the preferred embodiments of the present invention will be described in detail with reference to the drawings, black and white pictures. These pictures taken from A350 model airplane in the scale of 1:144 to show that the real life size airtrain can be made with the same design, two life size same-type of airliner jointed symmetrically rear to rear, FIG. 3. Doing some modifications required to transform the two same type of airliner into an airtrain, balanced and function like an airplane but looks and hauls passengers and cargo like a train. It will be safe, efficient, effective and airworthy to fly and meet all the standards of the Federal Aviation Administration or any other Aviation administrations requirements to fly in the ground effects over grounds or operate above the water.

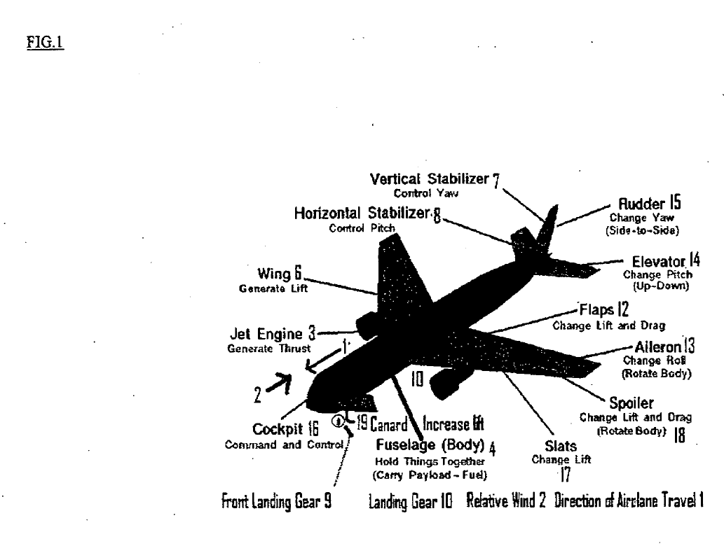

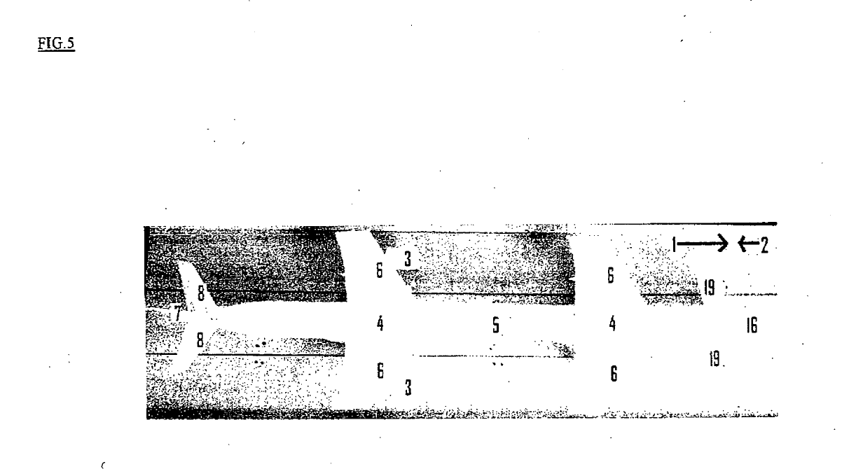

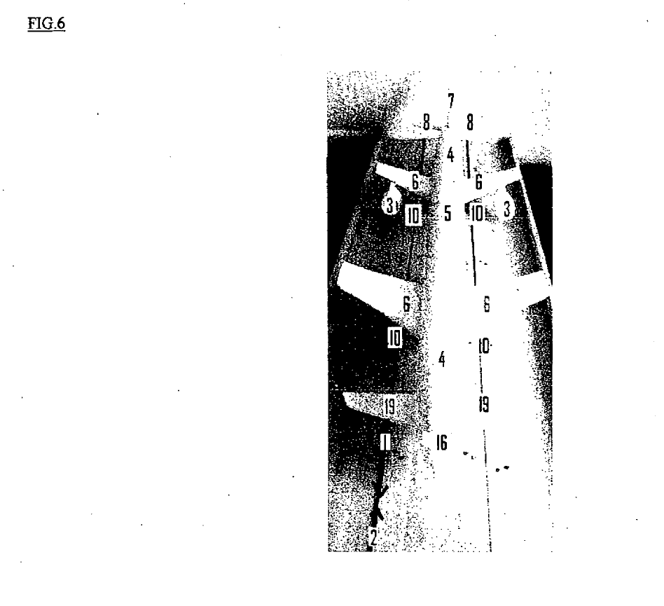

FIG. 1 is a drawing of an airliner with its parts and functions. Airliner and the airtrain have the same parts but in a different configuration but the airtrain will work the same way as an airliner. FIG. 1 is a legend; a diagram of the parts of the airliner and how they function are all the same on the airplanes and airliners. The new symmetric airliners will be no different. It has all the parts the same as a single body airliner and its functions of the parts are the still the same. This information is from the NASA website. The only thing different is that airliner is single airplane. Airtrain is two of the same type of airliner joined symmetrically to haul more passengers and cargo at one give time flying in ground effect. See FIG. 6.

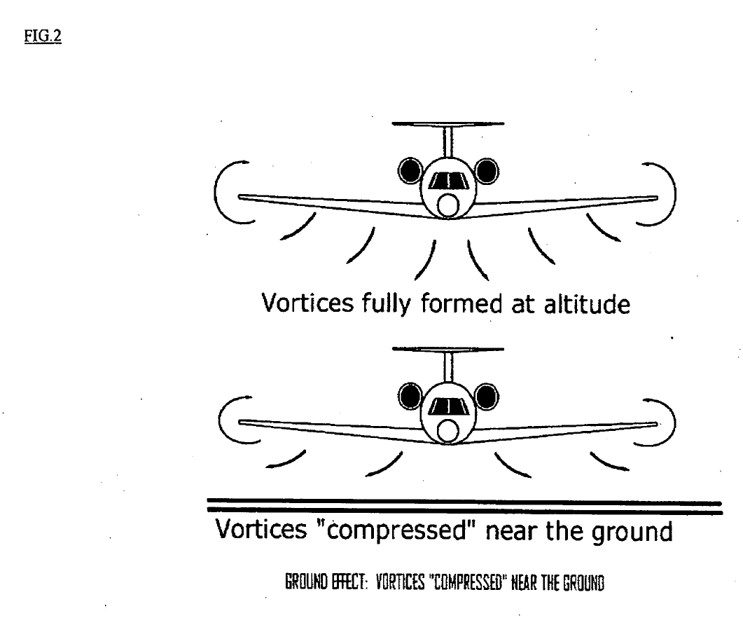

FIG. 2 a drawing of how the ground effects on an airplane. The ground effect is vortices, compressed near the ground, this phenomena takes place during the take offs and landings on every airplane. An airtrain will use this phenomenon is called ground effect during most part of its trip in the ground effect, flying low to the grounds or body of a water when a grounds are not available to fly over due to a densely populated areas or a terrain that is difficult to operate in the ground effects.

FIG. 3 a side view of the two same-type A350 model airplanes, airliners jointed rear of the airliner to the rear part of the airliner would look like. The 4s are the fuselage and 5 is the where the two airliners are jointed rear to rear of the airliner. 5 is also area of CG, center of gravity, even after all the other modifications made to the airtrain on both sides the CG will stay around the same point equal in balance on both half's and the looks.

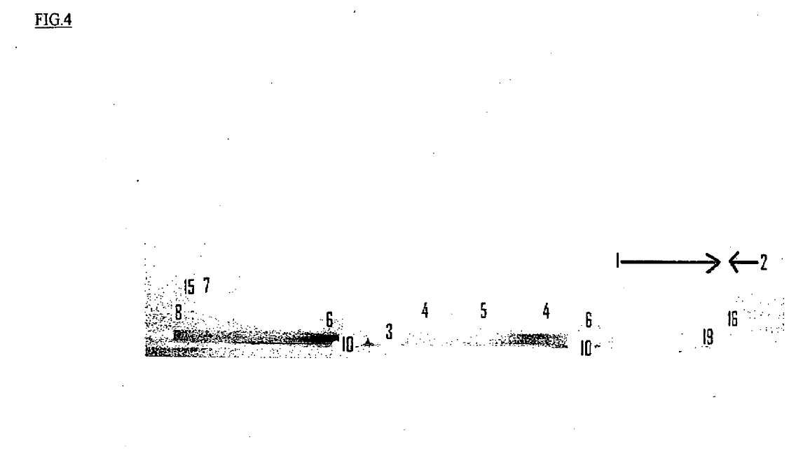

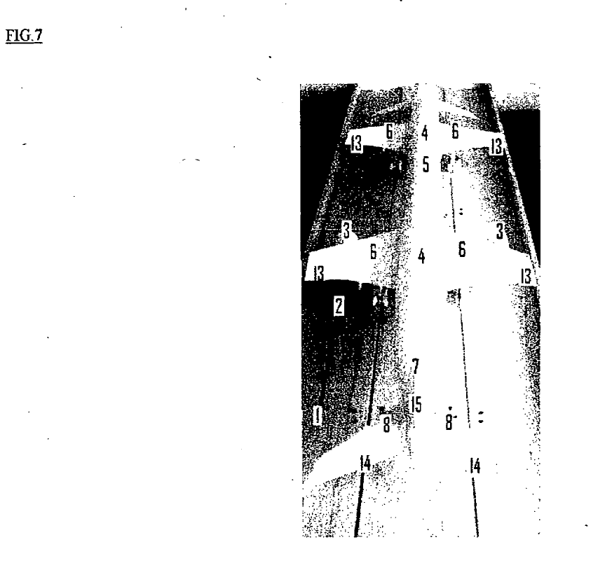

FIG. 4 shows how it would look when a two airliners are joined rear to rear. In this the cockpit 16 will be two, one on both ends. The vertical stabilizer 7 would need to be mounted on roof on the each end behind the cockpit 16 area. The rudder 15 on the vertical stabilizer 7 would work one at a time or work in the opposite ways. The rear of the direction of the movement 1 rudder will work. Or, have both rudders 15 to work together to assist in more smoothly changing the yaw by the rudder 15 moving in the opposite directions to give it a more coordinated turn. If one rudder 15 is used in turning all the time, than a bigger size of vertical stabilizer 7 and rudder 15 to compensate the weight and resisting force to over come sufficiently. The horizontal stabilizer 8 and elevator 14 configured on the front part of the airliner behind the 16 cockpit in the middle part of the fuselage 4 as shown on the FIG. 4 This too, they can work in conjunction or have them work separately. If they are working separately, than the appropriate sizes need to be installed to over come the resisting forces to raise or lower the front of the airliner in the direction the of the airliner movement 1. Front landing gear 1 can be optional, have or don't have. Four rear landing gear 10 in the center near the CG would give it more than enough to give it a stability during the take offs and landings. FIG. 8 is the top view of the rear to rear joining of the two same type of the airliner and as you can see it is perfectly symmetrical. FIG. 7 is the front view of the two same type of airliner joined. The front Horizontal stabilizers 8, elevators 14, vertical stabilizer 7 rudder 15, and cockpit will have the exactly the same ones in the back. The engines are indicated as 3 have four instead of 2 on a normal airliner. If the engines are facing the same way as it is shown on FIG. 9, the engines pointed in the opposite direction, engines in the opposite of the direction of the movement 1 can be used to pull out from the parking ramp area without the assistance from the airplane pusher vehicles. The configuration of the parts and what it needs does not change but the size or the surface area it needs may vary depending on the requirements of the airtrain to make smooth turns, up and down and bank left and right.

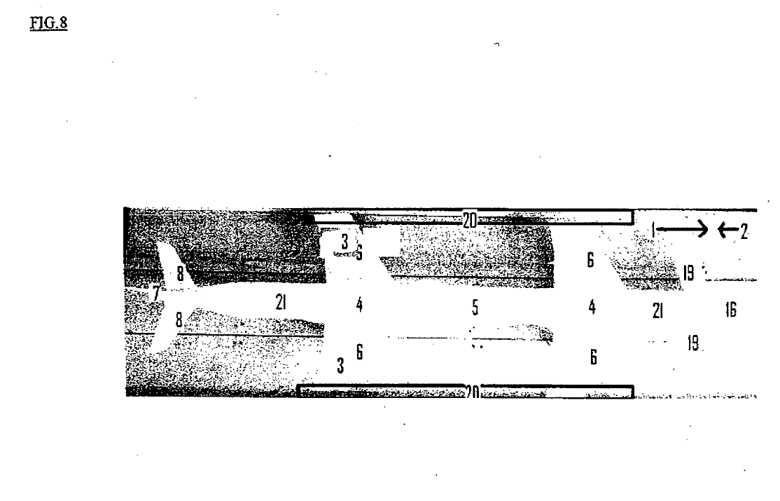

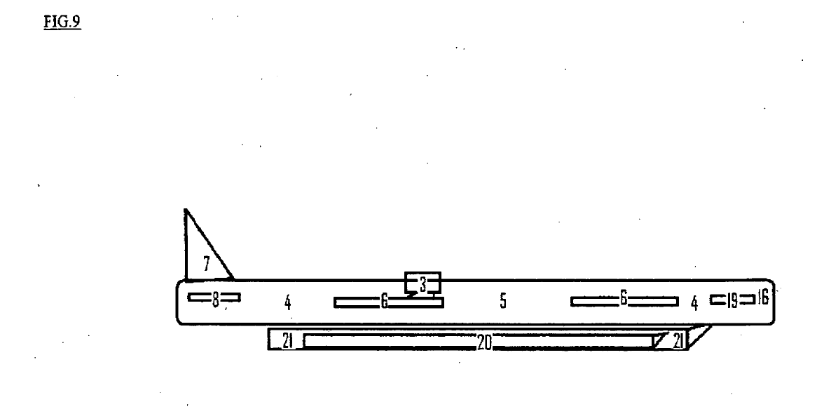

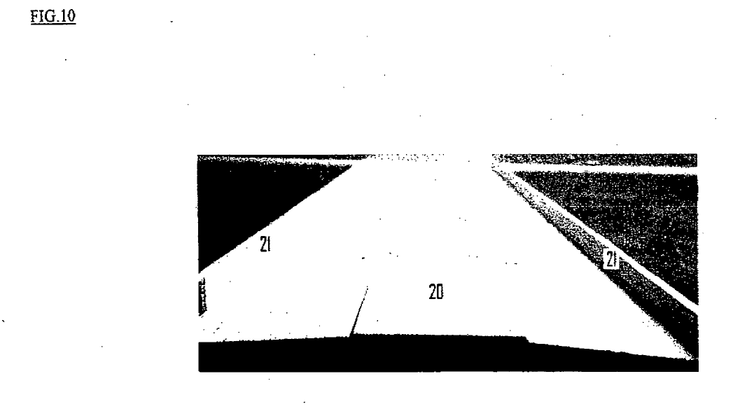

FIG. 4 in the direction of the movement as indicated the airtrains have four engines. It has several options. The engines can burn two at a time, for example use the two facing the direction of the movement 1 the airliner or have the engines to have a 180 degree rotation mechanism to face all the same way in the direction of the movement 1 as shown on the FIG. 7. All four engines would have this rotational mechanisms would allow the flexibility for the pilots to maneuver more effectively on the ground when they are taxing. The engines will be rotated so it is facing in the same direction. This is done before the take offs. If the engines are facing in the opposite directions, it can be used as emergency brakes when it fails to brake. Pilots can use the engines to bring the airplanes to stop or slow it down. FIG. 8 shows the top view of how it would look with all four engines facing the opposite direction of the movement 1. FIG. 9 shows the top view of all four engines facing in the same direction of the movement 1. The engines mounted on tope of the wings are for the hydroairtrain for the take offs and landings in the water. The engines would have to be water proofed so that it would not shot down during landings and take offs. See FIG. 10.

FIG. 5 is the perspective view of the airtrain model. All the parts and its functions are the same but in different configuration. Even in different configuration than an airliner, it will still have the same parts and their functions are still the same.

On the wings 6 may require some modifications on the flaps 12. On normal flaps on an airliner, when the flaps are extended it gives a great curvature to create more lift and drag. However on a symmetrical airliner it need to be shaped less curvature, more of straight, wing flaps extended it will just give a more of straight or little up flow to less interfere with the airflow flowing to the behind its wings. In fact it needs to be engineered to work together to give it more left with the reduced drag. Also the aileron 13s can work one set of time or to have working all four working together to give it more smooth turn. Or it can have both of the wings facing the same way as the direction of the take offs and the engines also facing the same way, the direction of the movement. Having the both wings the same way, is a better configuration, than it needs to be implemented. The wings can also be joined to give it better stability.

FIG. 6 is what an airtrain would look like flying with its landing gear out. Coming in for a landing, take off, to slow it down or land in case of an emergency, it would extend its landing gears. It has a spoiler's just line an airliner FIG. 5, 17. It can be used to slow the airtrain too. Only the one side, the direction of the movement side will be deployed to slow the airtrain down. FIG. 6, 6 the wings length is reduced to reduced the height of the ground effect the airtrain will be off the grounds or over the body of the water. The length of the wing and its size and shape need to be adjusted to give the airtrain the best performance and desired height it should fly in. Thus, the wings on the Airtrain can be shorter or longer depending on the flight characteristics that is most safe and performs best for the airtrain.

FIG. 7 is the front view of the airtrain on its ramp.

FIG. 8, it shows the perfect symmetry from the top view, both sides are the same and perfectly balanced. An airtrain have a double of every thing built in back up incase one fails. Cockpits, 16 are on both ends. So if one fails, one can use the other one. For safety the airliners have many redundant back up systems and symmetric airtrain would add more safety futures added to the redundancy to give it more added safety features and back ups for airtrain to operate with safety.

FIG. 9 is a top view of the airtrain the same as the FIG. 8 except the engines are faced in the same direction the direction of the movement of the airtrain. If the engines can be rotated mechanically it would be the best way to change the direction of the engines give it more power with four engines running rather than only two. If not, just have the two engines working, the engines facing the direction of the movement. If one engine fails the fails side of the rear engine can replaced the fail engine. With the four engines one can have more back up incase of one fails or configurations as to making the flight safer.

FIG. 10 shows hydroairtrain, a top view of the airtrain the same as the FIG. 8 except its engines are mounted on top of the wings for operational take off and landings in the body of open water. Also added are the pontoons 18 on both end of the wing to give it more stability when it is in the water. For the operation in water the other safety futures and added shape on the fuselage, body, will be slight different or added futures to cut through the better water better but the basic looks, configuration and functions of the airtrain parts stays the same.

FIG. 10 is a side view of the airtrain how the ramp would look like. For the safety and incase of emergency, it would fly in the ground effect flying on or near the ramp throughout its trip. It is not required but incase of emergency, it offers a place to land safely. Airtrain can follow a road or ramps. It will be done all automatically as it is with airplanes. It will follow the roads and ramp it is sign to. One ramp can be used by both going and returning trains. It can have a lateral separation and vertical separation when it is passing each other. Since it is not confined to the tracks or electrical lines it can have a greater safer margin of separation to keep each other from interfering with its travel. Incase of emergency, airtrain can land on its ramps, get serviced and take off again. If it can not be fixed, another airtrain would land forward of it and pick up the passengers and proceed with its destiny. No need to worry about one airtrain holding up the line as it is in a tracked trains where if one is down in mid trip on a track it can hold up a next train from its departure. The ramp is a road; we know how to build roads and can make it cheaper. FIG. 11, 20 is the essentially a road. 21 is a small guard rail it prevents from small garbage from getting blown in to the ramp. The ramp is low enough so that it does not interfere with airtrains from taking off and landings especially with the engines that are hanging lower.

FIG. 12 is the top view of what the ramps may look like. FIG. 13 is a front view. The airtrain ramp is an essentially a road that can handle the landing weight of an airtrain. It needs to engineer so that it will be free from the accumulation of water, snow, or debris that may picture the tires or debris getting sucked in the engines and damaging the airtrain engines. The some parts, it may even need a heating elements built on it so it can melt the snow and ice from cumulating which can prevent the emergency usage.

This will most definitely supplement the speed train industry or replace. It will all depends on the airtrain can prove its effectiveness in safety and be able to haul the passengers and cargo at a reasonable speed and cost to build. In translation, cheaper fairs and faster travel for the passengers and moving of cargo is a positive signs on how the airtrain or hydoairtrain can supplement the speed train in the future.

1. Air-Train comprised of half airplane and half-train meaning it is made of two same type of airliner joined rear to front of the airliners, equal in weight on both side of the center of gravity. All parts and functions operate exactly the same as airliner. Jet engines are used to power, fly in ground effect, vortices formed result of the air over the wings creating lift. In ground effect the vortices are compressed near the ground, thus causing the airliner to flow on a ground or body of the water. Thu Air-Train does not require any steel tracks, platforms, electricity, electric grids. At the same time it has train characteristics is that it can carry passengers like the train and cargo in mass in ground effects, low to the ground or over the body of water.

2. Two airliners are symmetrical and the way it is joined is tail portion is removed and the other airliner the cockpit is removed. The two are joined rear part of airliner to the front part of the airliner. Two airliners joined but the controls and the functions are all the same as a single airliner.

3. The fuselage length is equal in weights over the center of gravity. There are four wings, two wings on each set of airliner creating lift. All wings can be the same shape as the airliner or elliptical and rounder to create more lift even during a slow speed. The wings are shortened for the reasons of preventing a wing to clip the ground or body of the water and also to generate the ground effect. The size and shape will be shaped with the regards to the safety and to create the maximum around effect. Regardless of the shape, the each wing will create equal lift on all wings to prevent stress on the center of gravity where the two airliners are joined.

4. The two engines are in the rear of the two wings. One engine on each wing to reduce the turbulence to maximum level. The engines will be strong enough to power using only one engine incase if one of the engine quits.

5. The center of gravity, where the two are joined, need to be reinforced to endure even the any irregularity in lift. As the equal lifts is generating from all the wings the stress will not be a big factor still reinforcement will erase any safety issues. The attachment of the two fuselages will be newly designed large bulkhead frame and skin splice at each intersection.

6. The landing gears are four sets, two sets on each body as it is under the each main wing. The landing gear will need to be longer to help clear the rear tail portion of the airliner during the take off and landings. The strengthen the landing gears maybe required to take on greater loads from the eliminated front landing gears from the both airliners that were joined.

7. The jet engines are mounted in the rear set of wings, one on each wing. Each engine will be more than enough power to operate as one engine incase one engine do malfunction. The engines can be turbofans, turbo-prop, prop-fan, gas turbine, internal combustion engine or other engine (counter or contra rotation propeller system) delivering shaft horsepower to the propellers.

8. Horizontal stabilizer maybe has to be bigger in the size in order to control the additional weight and load in the front.

9. Vertical stabilizers maybe have to be bigger in the size in order to control the additional weight and load in the front.

10. Hydro Air-Train is a air-train that has a capability to land and take off from the water. The engines are mounted on the top; engines will have functions and cover to prevent the water intake from the open water. The long float/ski is fitted on end of the wings on both sides connected to the front and back wings. Also the long ski is fitted on the bottom center of the air-train fuselage. The hydro Air-Train will land with along the side of the incoming waves and not directly face on coming waves.
